(19) United States
(12) Patent Application Publication
(10) Pub. No.: US 2006/0061542 A1
(43) Pub. Date: Mar. 23, 2006

(54) Dynamic character display input device

(76) Inventor: Dragan Z. Stokic, Tucson, AZ (US)

Correspondence Address: QUARLES & BRADY STREICH LANG, LLP, ONE SOUTH CHURCH AVENUE, SUITE 1700, TUCSON, AZ, 85701-1621, US

(21) Appl. No.: 10/948,382

(22) Filed: Sep. 23, 2004

(51) Int. Cl. G09G 5/00

(52) U.S. Cl. 345/156

(57) ABSTRACT

An input device including an illuminated keyboard and a display controller for displaying characters on depressible keyboard locations or buttons. The display controller changes the displayed characters according to a selection of a character set and application of modifiers, such as shift, alternate, or control. The input/output device also includes a light sensor for sampling the ambient light level in the vicinity of the input/output device. Based on the ambient light level, the display controller adjusts the intensity of the displayed character, its background, and the contrast between the displayed character and its background. The depressible keyboard locations may be buttons connected to mechanical switches to allow a user to rapidly type information into the input device. The display controller can be controlled by either user-selectable switches or by the operating system or software applications of an attached computing device.

### BACKGROUND OF THE INVENTION

1. Field of the Invention

This invention is related in general to digital input/output devices. In particular, the invention consists of a programmable illuminated keyboard for use with a computing device.

2. Description of the Prior Art

Input devices are used to transmit information to computing devices, such as general purpose computers and personal digital assistants (“PDAs”). One such device is a keyboard designed to allow a user to send information corresponding to the depression of keys to a general purpose computer. This information is used to control the operation of the general purpose computer, affect the behavior of software applications, or to compile a document, spreadsheet, or database. This information may be transmitted by the keyboard as either analog or digital information.

An analog input device produces an analog electric signal that is captured at the target device and converted to digital information. A digital input device converts keystrokes into digital values and transmits the digital values to the target device. A common scheme for transmitting digital information is the American Standard Code for Information Interchange (“ASCII”). Because computers utilize a binary coding scheme for reading, interpreting, processing, and storing information, a number representation is assigned to each keystroke of an input device. For example, a capital letter “A” is assigned a decimal numeric value of 65. This decimal value is read by a computing device as a binary representation of ones and zeroes: 01000001. A lower case letter “a” is assigned a decimal numeric value of 97. This decimal value is ready by the computing device as the binary number 01100001. In this manner, computing devices are capable of distinguishing between and assigning numeric values to each keystroke occurring on an input device.

While the original ASCII standard included 128 discrete characters, and extended set of 128 ASCII characters has been added. Traditional operating systems used in the United States by English speaking persons are optimized to interpret keystrokes according to the standard and extended ASCII standards. However, users wishing to input information using a non-English language may use operating systems and software applications that interpret keystrokes according to a non-ASCII standard. An example is a person wishing to type a document in the Chinese language using keystrokes that correspond to Chinese characters.

Traditionally, using a non-ASCII standard required the use of a keyboard specifically adapted for that particular use. Alternatively, overlays could be placed over traditional English keyboards to cover the ASCII characters with non-ASCII characters. In this manner, the character displayed on a keyboard button would correspond to the non-ASCII character interpretation of the operating system or software application.

A problem occurs if a person wishes to utilize a non-English version of an operating system, but does not have access to a corresponding keyboard or overlay. One approach is to memorize the corresponding keyboard buttons. However, this approach is impractical for most users as they are unwilling or unable to memorize a sufficient number of corresponding buttons. Accordingly, it would be advantageous to have a keyboard that can be adapted to a person's preferred character set without requiring an overlay.

Another problem with traditional keyboards is that multiple characters can be transmitted by depressing the same keyboard button by applying modifiers, such as the alternate key, the control key, the shift key, the caps lock key, or the num lock key. FIG. 1 illustrates the characters displayed on a traditional US-English 104 key keyboard 10. Depressing the “A” keyboard button 12 traditionally transmits the ASCII code for the lower case “a”. However, by simultaneously depressing the shift key 14, the ASCII code for the upper case “A” is transmitted. Other ASCII characters are transmitted if the alternate key 16 or control key 18 has been depressed, activating their corresponding modifiers. For example, while working on a document in Microsoft Word®, depressing the “x” keyboard button while simultaneously depressing the control key will cut (remove and place in a hidden notepad for later retrieval) highlighted text from the document. Depressing the “v” keyboard button while simultaneously depressing the control key will insert the previously cut information into the document at a position defined by a cursor. A user traditionally must memorize the functions of key combinations such as these, or must access the functions through drop-down menus, requiring additional keystrokes and time. Accordingly, it would be advantageous to display current keyboard button functionality at the user-selectable locations based on which modifier keyboard buttons are currently depressed or in effect.

Another issue with input devices is that they are often attached to mobile computing devices, such as lap-top computers. These mobile computing devices are used in a variety of environments, from a brightly illuminated traditional office to a airplane seat with moderate illumination to a vehicle operating in bright sunlight or at night time. This varying amount of illumination makes it difficult for a user to see the characters associated with a keyboard button. Accordingly, it is desirable to have an input device wherein the keyboard buttons may be illuminated. Additionally, it is desirable that the degree of illumination vary in response to the level of ambient light present in the vicinity of the input device.

Input devices, such as keyboards, have traditionally been mechanical input devices that convert mechanical depression of keyboard strokes into voltage signals. However, recent innovations, such as computer touch-screens, are capable of sensing a depression in a liquid-crystal display or the position of a pointer and translate these actions into corresponding characters. However, rapid input of information is traditionally accomplished by typing, i.e., the mechanical depression of keyboard buttons with associated keyboard switches. Accordingly, it would be desirable to have an input device with mechanically depressible keyboard buttons that display characters corresponding to the character code that will be transmitted if depressed, as interpreted by the operating system and software application in light of which, if any, modifier keys are active.

### SUMMARY OF THE INVENTION

The invention disclosed herein is an input device adapted to display characters, groups of characters, words, shortcuts, or graphics at user-selectable locations. Information is transmitted from the input device to a target computing device in a binary representation of characters associated with selected locations. The characters displayed at the user-selectable locations changes depending on which character set is utilized by the target computing device, either by an operating system or a software application. Additional character sets are alternatively displayed at the user-selectable locations based on the application of modifiers.

An important aspect of this invention is that the input device can display either ASCII characters or non-ASCII characters based on the needs of the user, without requiring a special-purpose input device or an overlay. This is advantageous as it allows a single input device to be utilized with a multitude of character sets, eliminating the need for purchasing multiple input devices or overlays.

Another advantage of this invention is that the user-selectable locations are illuminated, allowing the input device to work in a variety of light conditions. This is accomplished by using a light sensor to measure the level of ambient light in the vicinity of the input device and adjusting the light intensity of the displayed characters, as well as their background illumination and contrast levels. Optionally, the light intensity may be adjusted manually by the user.

Yet another advantageous of the invention is that the character display area may be placed on the working surface of mechanically depressed switches, such as a keyboard's buttons. This allows a user to enjoy the advantages of a touch-screen while enjoying the speed and efficiency of a mechanical-switch input device.

Various other purposes and advantages of the invention will become clear from its description in the specification that follows and from the novel features particularly pointed out in the appended claims. Therefore, to the accomplishment of the objectives described above, this invention comprises the features hereinafter illustrated in the drawings, fully described in the detailed description of the preferred embodiments and particularly pointed out in the claims. However, such drawings and description disclose just a few of the various ways in which the invention may be practiced.

### BRIEF DESCRIPTION OF THE DRAWINGS

FIG. 1 is a block diagram illustrating the characters displayed on the keyboard buttons of a traditional US-English 104 key keyboard.

FIG. 2 is a block diagram illustrating a dynamic character display system, according to the invention, including a light sensor, a display controller, optional user-selectable switches, and an input device with a keyboard including a plurality of user-selectable locations.

FIG. 3a is a block diagram illustrating the ASCII characters that are displayed on the user-selectable locations of a 104 key keyboard, according to the invention, and transmitted to a computing device when the user-selectable locations are selected and no modifiers are active.

FIG. 3b is a block diagram illustrating the ASCII characters that are displayed on the plurality of user-selectable locations of the 104 key keyboard of FIG. 3a, according to the invention, and transmitted by selecting the caps-lock modifier key in conjunction with the plurality of user-selectable locations.

FIG. 3c is a block diagram illustrating the ASCII characters that are displayed on the plurality of user-selectable locations of the 104 key keyboard of FIG. 3a, according to the invention, and transmitted by selecting the control modifier key in conjunction with the plurality of user-selectable locations.

FIG. 3d is a block diagram illustrating the ASCII characters that are displayed on the plurality of user-selectable locations of the 104 key keyboard of FIG. 3a, according to the invention, and transmitted by selecting the num-lock modifier key prior to selecting the user-selectable locations.

FIG. 4 is a block diagram illustrating the dynamic character display system of FIG. 2, wherein the input device includes a character set interpreter.

FIG. 5 is an illustration of a user-selectable location of the input device of FIG. 2, including a display surface that can be illuminated to display characters.

FIG. 6 is a block diagram illustrating the characters displayed on a plurality of user-selectable locations of an 88 key keyboard and transmitted to a computing device, according to the invention, when the user-selectable locations are selected and no modifiers are active.

FIG. 7 is a block diagram illustrating the Serbian-Cyrillic characters that are displayed on the plurality of user-selectable locations of the 88 key keyboard of FIG. 6 and transmitted to a computing device, according to the invention, when a Serbian-Cyrillic keyboard layout has been loaded into a display controller and the user-selectable locations are selected.

### DESCRIPTION OF THE PREFERRED EMBODIMENTS

This invention is based on the idea of utilizing an input/output device to display a multitude of character sets for selection by a user and subsequent input into a computing device. The invention disclosed herein may be implemented as a method, apparatus or article of manufacture using standard programming or engineering techniques to produce software, firmware, hardware, or any combination thereof. The term “article of manufacture” as used herein refers to code or logic implemented in hardware or computer readable media such as optical storage devices, and volatile or non-volatile memory devices. Such hardware may include, but is not limited to, field programmable gate arrays (“FPGAs”), application-specific integrated circuits (“ASICs”), complex programmable logic devices (“CPLDs”), programmable logic arrays (“PLAs”), microprocessors, or other similar processing devices.

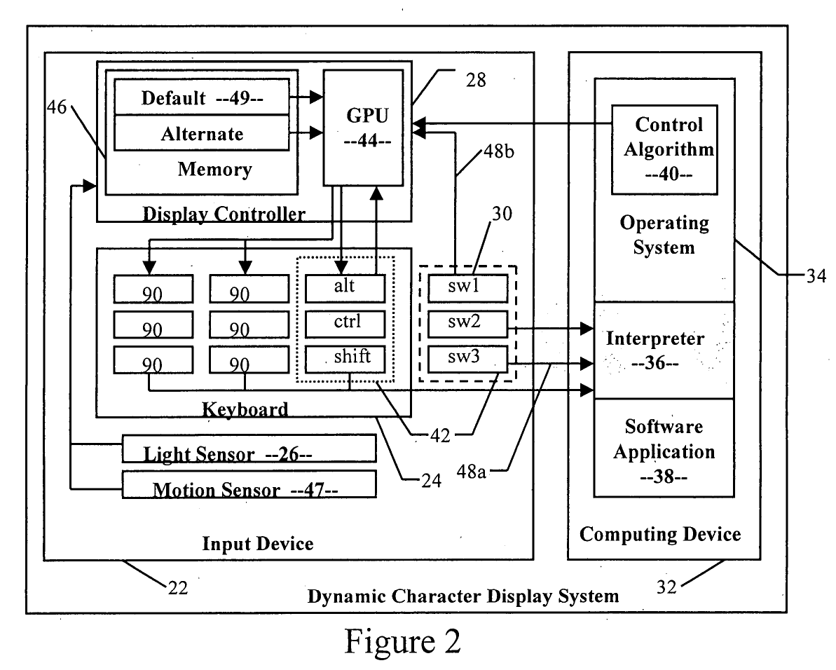

Referring to figures, wherein like parts are designated with the same reference numerals and symbols, FIG. 2 is a block diagram illustrating a dynamic character display system 20, according to the invention, including a dynamic character display input device (“input device”) 22 with a keyboard 24, a light sensor 26, and a display controller 28. The keyboard 24 may assume one of a multitude of different layouts of discrete user-selectable locations, such as a traditional US-English 104 key keyboard. For purposes of this invention, discrete user-selectable locations are defined as multiple selectable areas separated from each other by non-selectable areas, such as a mechanical keyboard composed of numerous depressible buttons. These layouts of discrete user-selectable locations are distinguished from touchscreens and touchpads which are continuous surfaces lacking depressible buttons, such as those using springs or bubble membranes.

The light sensor 26 measures the level of ambient light in the vicinity of the input/output device 22 and communicates this information to the display controller. The display controller transmits characters, groups of characters, words, shortcuts, or graphics to each individual user-selectable location and adjusts the intensity of the transmitted information, including the brightness of the background and the contrast between the transmitted information and the background.

A computing device 32 accepts input data signals transmitted by the keyboard 24 for input into the operating system 34. A character set interpreter 36 decodes the received signals and passes the decoded information for use by the operating system or software applications 38 such as word processors, spreadsheets, or databases. In this embodiment of the invention, a control algorithm 40 residing within the operating system 34 dictates which character set is loaded into the display controller 28. Optionally, the control algorithm 40 may be a separate software application. An alternate means for controlling the display controller 28 is through the selection of the optional user-selectable switches 30.

Another feature of the invention is a reduction of visual information placed at the user-selectable locations. For example, a traditional US-English 104 key keyboard layout may includes a number pad that includes user-selectable locations that have more than one character displayed on them. For example, the “8” key also includes an upward pointing arrow and the “2” key also includes a downward pointing arrow. This cumulative display of information on a single user-selectable location is eliminating by displaying only one character or the other, depending on which, if any, modifier is active.

In this embodiment of the invention, the information displayed at the user-selectable locations is transmitted by the display controller 28 according to which character set is loaded and whether any modifiers 42 are active. Modifiers are any combination of user-selectable locations or user-selectable switches 30 that, when activated, change the display information provided by the display controller. When no modifiers 42 are selected, a default keyboard layout is transmitted by the display controller 28 to the keyboard 24. However, selecting a shift modifier 42 will cause a different keyboard layout to be transmitted from the display controller 28 to the keyboard 24.

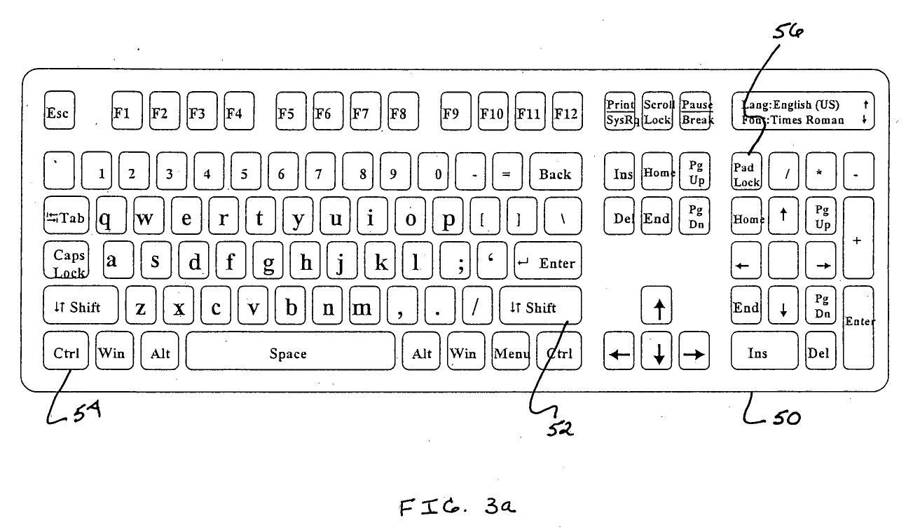

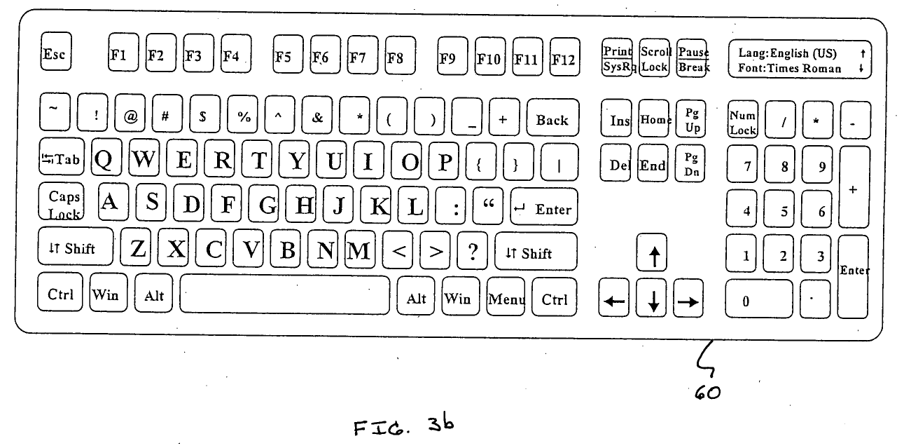

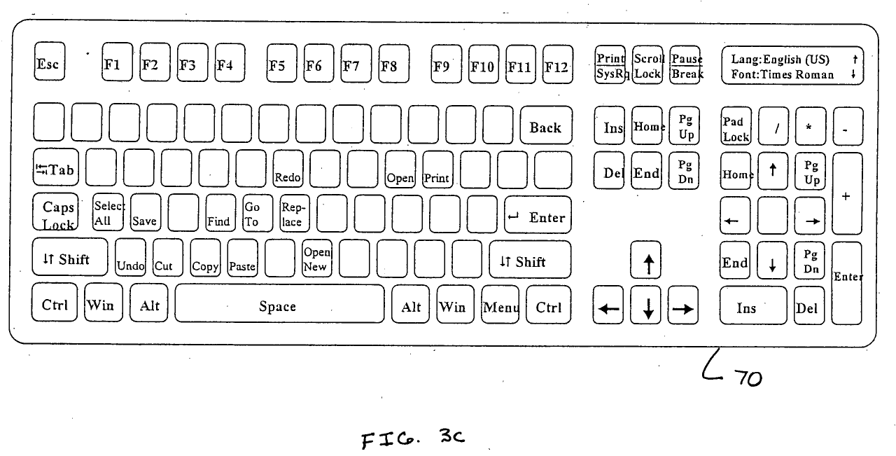

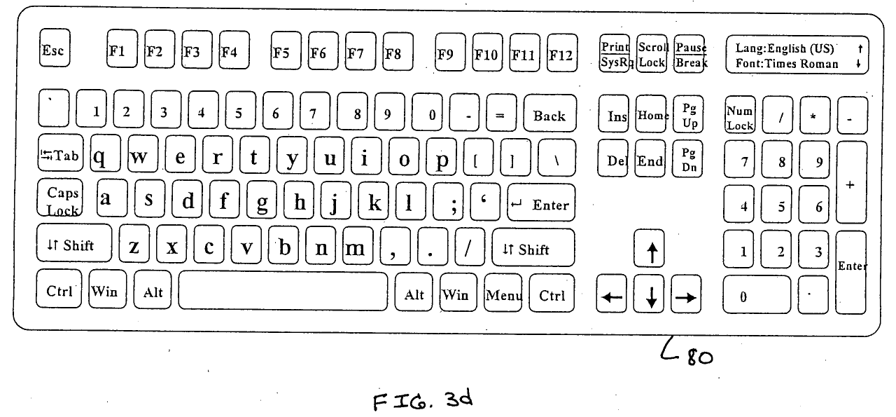

If the display controller originally transmitted the character set for a traditional US-English 104 key keyboard layout 50 as shown in FIG. 3a, selecting the shift modifier 52 would cause the displayed character set to be replaced by the upper-case US-English 104 key keyboard layout 60 of FIG. 3b. FIG. 3c illustrates the control character set layout 70 transmitted for display by the keyboard 24 of FIG. 3a, if the control modifier 54 (FIG. 3a) is selected and the display controller is configured to transmit display information useful for the utilization of a software application, such as Microsoft Word®. FIG. 3d illustrates the num-lock character set layout 80 transmitted by the display controller 28 in response to a user selecting the num-lock modifier 56 (FIG. 3a).

The various character sets displayed by the display controller are loaded into a graphical processing unit (“GPU”) 44 (FIG. 2) from a local memory unit 46 or from the control algorithm 40. If the character sets are loaded by the control algorithm 40, then a selection of a modifier results in a modifier signal 48a being transmitted to the operating system 34 for use by the control algorithm 40. Otherwise a modifier signal 48b is transmitted to the display controller 28.

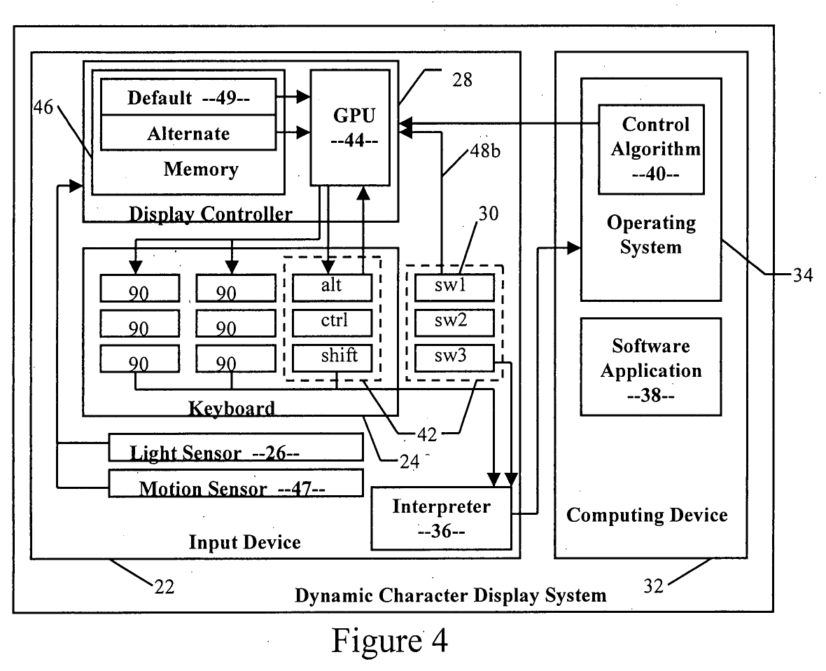

In this embodiment of the invention, selecting a particular user-selectable location results in a fixed associated numeric value being transmitted to the operating system 34, regardless of which character set is active in the display controller 28. However, as illustrated in the block diagram of FIG. 4, the character set interpreter 36 may alternately be located within the input/output device 22 rather than the computing device 32. This allows the display controller to direct what numeric values are transmitted to the operating system 34 in response to activation of user-selectable locations within the keyboard 24.

In one embodiment of the invention, the user-selectable locations are a collection of depressible buttons, such as keyboard keys. Keyboard keys are typically discrete areas separated from each other by non-selectable areas that are depressible and usually include springs or bubble membranes. One feature of a typical keyboard key is that it can be manipulated very rapidly by a user and provide tactile feedback, in contrast to visual representations of buttons displayed by touchscreens and touchpads. These keyboard keys allow a user to rapidly type information for use by the operating system 34 or software application 38.

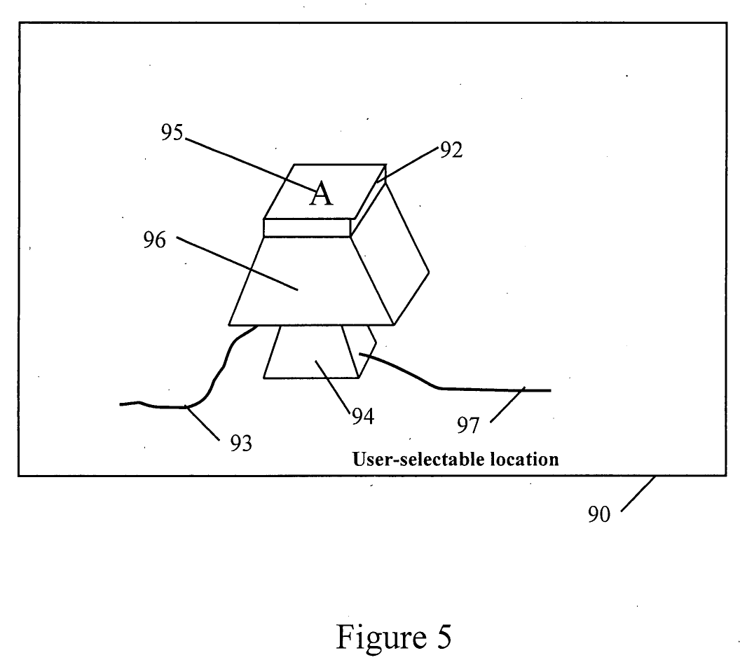

One such user-selectable location 90 is a depressible button as illustrated in FIG. 5, including a display surface 92 and a switch 94. The display surface 92 may be placed on top of (at the working surface of) the depressible buttons 90 or may be placed on any side 96. The purpose of the display surface is to display a character, a set of characters, a word, an application shortcut, or a graphical image. Display information 93 is received by the user-selectable switch and transmitted as visual information 95 from the display surface 92. This provides the user with a visual reference as to the current function of a user-selectable location 90. When the user-selectable location 90 is depressed, the switch 94 creates an input data signal 97 that is transmitted to the computing device 32.

One use for this feature is that application shortcuts, such as the copy function in Microsoft Word®, can be displayed on the user-selectable location corresponding to “c” on a traditional US-English 104 key keyboard layout when the alternate modifier 56 (FIG. 3a) is selected. Other exemplary uses include showing pictures such as an apple when used with a children's learning software application. Alternatively, if no software applications 38 are active, the display controller can load a default character set 49 (FIG. 2), such as the extended ASCII character set, into the GPU 44.

Another aspect of the invention is the use of a motion sensor 47 to activate the display of characters at the user-selectable locations. If no activity is detected by the motion sensor for a pre-determined period of time, the display surfaces 92 (FIG. 5) are turned off to save power or reduce visual distraction to a user or persons in the vicinity of the input device 22. Once the display surfaces 92 are dormant, movement of a user's hand toward the keyboard 24 is detected by the motion sensor 47 which, in turn, activates the display surfaces 92. If the motion sensor 47 has been de-activated, pressing any key will serve the same function.

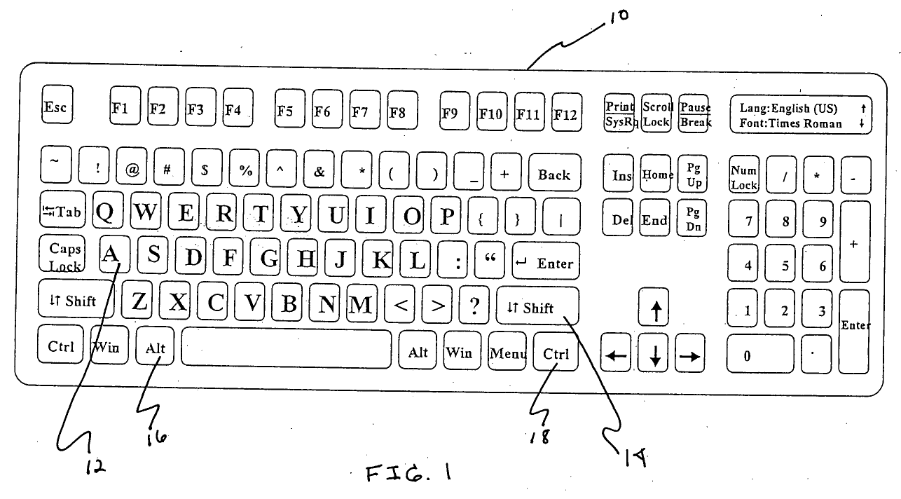

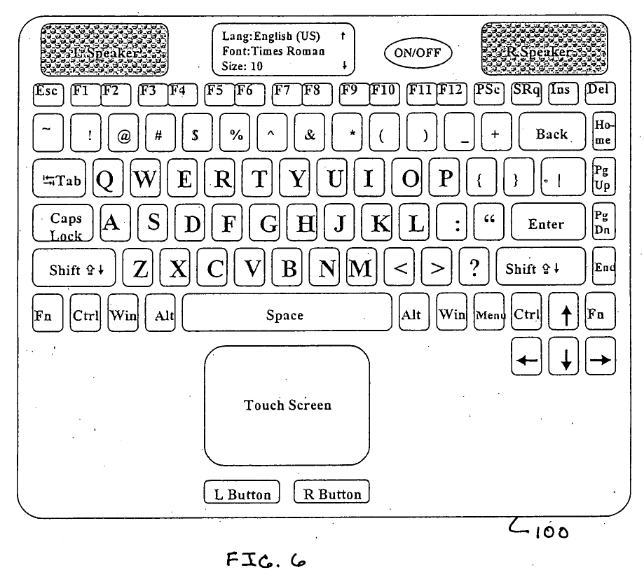

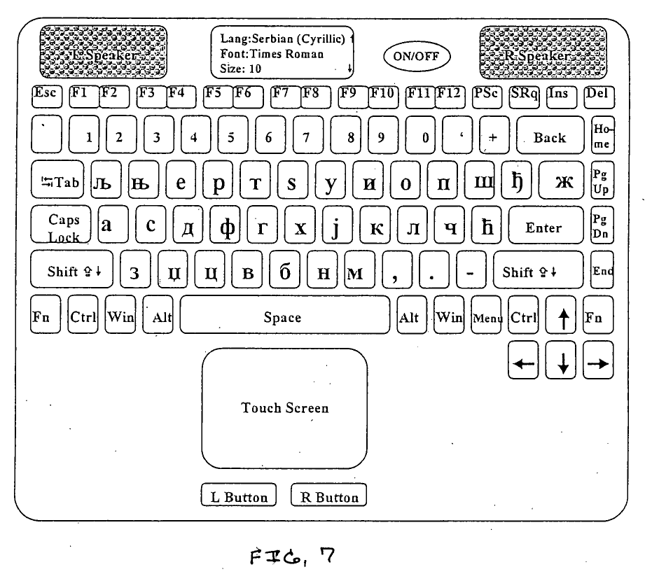

Another purpose of the invention is to allow one or more users to change which language is used to input information into the computing device 32. For example, a US-English 88 key keyboard layout 100 is illustrated in FIG. 6. By changing the user-selectable switches 30 (FIG. 2) or changing the control algorithm 40 (FIG. 2), the Serbian-Cyrillic 88 key keyboard layout 110, as shown in FIG. 7, can be loaded into the GPU 44 (FIG. 1) for display on the keyboard 24. This allows users to utilize multiple languages without require separate keyboards 24 or overlays.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

I claim:

1. A dynamic character display input device, comprising:
a display controller for transmitting display information; and
a plurality of discrete user-selectable locations for receiving said display information, each of said plurality of discrete user-selectable locations including a display surface for transmitting a visual representation of said display information and including a switch for creating an input data signal indicative of a user's selection of said each of said plurality of discrete user-selectable locations.

2. The dynamic character display input device of claim 1, wherein said visual representation includes a character.

3. The dynamic character display input device of claim 2, wherein said character conforms to an American Standard Code for Information Interchange (“ASCII”) standard.

4. The dynamic character display input device of claim 2, wherein said character conforms to an Extended American Standard Code for Information Interchange standard.

5. The dynamic character display input device of claim 1, wherein said visual representation includes a plurality of characters.

6. The dynamic character display input device of claim 1, wherein said visual representation includes a word.

7. The dynamic character display input device of claim 1, wherein said visual representation includes a representation of a software function.

8. The dynamic character display input device of claim 7, wherein the software function is a software application shortcut.

9. The dynamic character display input device of claim 1, wherein said visual representation includes a graphical image.

10. The dynamic character display input device of claim 1, further comprising a light sensor for measuring an ambient light level at the plurality of discrete user-selectable locations.

11. The dynamic character display input device of claim 10, wherein the ambient light level is communicated to the display controller and the display controller adjusts said display information.

12. The dynamic character display input device of claim 1, further comprising a motion sensor.

13. The dynamic character display input device of claim 12, wherein the motion sensor is adapted to communicate an indication of non-movement to the display controller, and the display controller is adapted to stop transmitting display information in response to said indication of non-movement.

14. The dynamic character display input device of claim 13, wherein the motion sensor is adapted to communicate an indication of movement to the display controller, and the display controller is adapted to start transmitting display information in response to said indication of movement.

15. The dynamic character display input device of claim 1, further comprising a memory device containing a first representation of a first keyboard layout, wherein said first representation is loaded into said display controller, and said display information conforms to said first keyboard layout.

16. The dynamic character display input device of claim 1, further comprising a user-selectable switch including a first position and a second position, and a memory device containing a first representation of a first keyboard layout and a second representation of a second keyboard layout;
wherein, when said user-selectable switch is at said first position, the first representation is loaded into said display controller and said display information conforms to said first keyboard layout; and wherein, said user-selectable switch is at said second position, the second representation is loaded into said display controller and said display information conforms to said second keyboard layout.

17. The dynamic character display input device of claim 16, wherein said user-selectable switch is a modifier key.

18. The dynamic character display input device of claim 17, wherein said modifier key is a control key.

19. The dynamic character display input device of claim 17, wherein said modifier key is a shift key.

20. The dynamic character display input device of claim 17, wherein said modifier key is a caps-lock key.

21. The dynamic character display input device of claim 17, wherein said modifier key is a num-lock key.

22. The dynamic character display input device of claim 17, wherein said modifier key is an alternate key.

23. The dynamic character display input device of claim 17, wherein said first keyboard layout is a US-English 104 key keyboard layout.

24. The dynamic character display input device of claim 17, wherein said first keyboard layout is a US-English 88 key keyboard layout.

25. The dynamic character display input device of claim 24, wherein said second keyboard layout is a Serbian-Cyrillic 88 key keyboard layout.

26. A dynamic character display input device, comprising:
a memory device containing a first representation of a first keyboard layout and a second representation of a second keyboard layout;
a display controller adapted to transmit display information including foreground intensity, background intensity, and contrast level;
a plurality of discrete user-selectable locations adapted to receive said display information, each of said plurality of discrete user-selectable locations including a display surface adapted to transmit a visual representation of said display information and a switch adapted to transmit input data indicative of a user's selection of said each of said plurality of discrete user-selectable locations;
a light sensor for measuring an ambient light level at the plurality of discrete user-selectable locations, wherein the ambient light level is communicated to the display controller and the display controller adjusts the foreground intensity, background intensity, and contrast level to enhance a user's ability to see the transmitted visual representation;
a motion sensor for providing an indication of non-movement and an indication of movement at the plurality of discrete user-selectable locations, wherein, if the indication of non-movement is communicated to the display controller, the display controller stops transmitting display information, and further wherein, if the indication of movement is communicated to the display controller, the display controller starts transmitting display information; and
a user-selectable switch including a first position and a second position, wherein, if said user-selectable switch is at the first position, said first representation is loaded into said display controller and said display information conforms to said first keyboard layout, and wherein, if said user-selectable switch is at the second position, said second representation is loaded into said display controller and said display information conforms to said second keyboard layout.

27. A method of inputting information into a computing device, comprising the steps of:
transmitting display information to a plurality of discrete user-selectable locations;
transmitting a visual representation of said display information from the plurality of discrete user-selectable locations;
creating an input data signal indicative of a user's selection of one of said plurality of discrete user-selectable locations; and
transmitting said input data signal to said computing device.

28. The method of claim 27, further comprising the step of:
determining an ambient light level at the plurality of discrete user-selectable locations; and,
adjusting the display information, including foreground intensity, background intensity, and a contrast level, to enhance a user's ability to see said visual representation.

29. The method of claim 27, further comprising the steps of:
determining an indication of non-movement at the plurality of user-selectable locations; and
discontinuing transmission of said visual information in response to said determining an indication of non-movement.

30. The method of claim 27, further comprising the steps of:
determining a first position of a user-selectable switch; and transmitting display information conforming to a first keyboard layout in response to said first position of a user-selectable switch.

31. The method of claim 30, further comprising the steps of:
determining a second position of the user-selectable switch; and
transmitting display information conformation to a second keyboard layout in response to said second position of the user-selectable switch.
